(19) United States
(12) Patent Application Publication
(10) Pub. No.: US 2020/0198610 A1
(43) Pub. Date: Jun. 25, 2020

(54) ADAPTER BODY FOR A BRAKE APPLICATION DEVICE OF A VEHICLE BRAKING SYSTEM

(71) Applicant: ZF Active Safety GmbH, Koblenz (DE)

(72) Inventors: Klaus Lemke, Hanroth (DE); José Manuel Calvo Martinez, Kruft (DE)

(73) Assignee: ZF Active Safety GmbH, Koblenz (DE)

(21) Appl. No.: 16/643,572

(22) PCT Filed: Jul. 18, 2018
(86) PCT No.: PCT/EP2018/069488

§ 371 Date: Mar. 1, 2020

(30) Foreign Application Priority Data
Aug. 29, 2017 (DE) 10 2017 008 142.5

(51) Int. Cl. B60T 13/567; B60T 17/02

(52) U.S. Cl. CPC B60T 13/567; B60T 17/02

(57) ABSTRACT

The present invention relates to an adapter body for a brake application device of a vehicle braking system. The adapter body has a first bearing surface which is designed to bear against a bulkhead of a vehicle, and a second bearing surface which is designed to bear against the brake application device, wherein the first bearing surface and the second bearing surface are at a predetermined distance from one another. A receiving means for a portion of at least one fastening bolt for fastening the brake application device to a vehicle is configured in the adapter body.

### CROSS-REFERENCE TO RELATED APPLICATION

This application is a national stage of International Application No. PCT/EP2018/069488, filed Jul. 18, 2018, the disclosure of which is incorporated herein by reference in its entirety, and which claimed priority to German Patent Application No. 102017008142.5, filed Aug. 29, 2017, the disclosure of which is incorporated herein by reference in its entirety.

### TECHNICAL FIELD

The present invention relates to an adapter body for a brake application device of a vehicle braking system and also an adapter unit having an adapter body of this kind. A brake application device having an adapter body of this kind or an adapter unit of this kind is likewise the subject matter of the present invention.

### BACKGROUND

Adapter plates for brake application devices are known from documents EP 2 735 483 A1, JP 2016 124 344 A and JP 2016 124 355 A. These adapter plates have tension bolts which are coupled to the adapter plates in a tensile force-transmitting manner and fixedly connected to the vehicle.

### SUMMARY

A problem addressed by the present invention is that of providing an adapter body with a simple design on which no tensile forces act during the assembly and operation of a vehicle. This problem is solved according to the invention by an adapter body having the features of patent claim 1. Further advantageous embodiments are specified in the dependent claims.

The adapter body according to the invention for a brake application device of a vehicle braking system comprises a first bearing surface which is designed to bear against a bulkhead of a vehicle and a second bearing surface which is designed to bear against the brake application device. The second bearing surface is at a predetermined distance from the first bearing surface. A receiving means for a portion of at least one fastening bolt for fastening the brake application device to a vehicle is configured in the adapter body.

The adapter body according to the invention is preferably cup-shaped and has a simple design which means that additional fastening means for fastening the adapter body to a vehicle can be dispensed with. The adapter body can receive at least part of a fastening bolt in its receiving means. The at least one fastening bolt extends through the receiving means of the adapter body, as a result of which the adapter body can be held in a predetermined position between a bulkhead of a vehicle and the brake application device. No additional fastening means or fastening bolts via which tensile forces could be transmitted to the adapter bodies are required in order to hold the adapter body in its predetermined position on the vehicle. Due to the receiving means through which the at least one fastening bolt extends, the adapter body according to the invention is not exposed to tensile forces during assembly of the brake application device and also in the assembled state during operation of the vehicle, as there is no tensile force-transmitting connection either between the fastening bolt and the adapter body or between the adapter body and the vehicle. This means that the adapter body can permanently retain its shape and achieve a long service life. The adapter body can be produced by means of an injection molding process. The adapter body is preferably an aluminum injection-molded part.

The receiving means may, in addition, have a region for receiving a portion of a force input unit of the brake actuation device. The force input unit is coupled with a brake pedal in a vehicle and the adapter body can receive at least a portion of the force-input unit of the brake application device. Consequently, both the at least one fastening bolt and the force input unit can extend through the receiving means of the adapter body.

The receiving means of the adapter body may have at least one opening for passage of a portion of the at least one fastening bolt for fastening the brake application device to a vehicle. In addition, the receiving means may comprise a recess for passage of a portion of the force input unit of the application device.

The adapter body may have a connection portion. The preferably cylindrical, but alternatively also conical, connection portion may connect the first bearing surface and the second bearing surface to one another. In addition, the connection portion may set a predetermined distance between the first bearing surface and the second bearing surface. The first bearing surface and the second bearing surface may run at least approximately parallel to one another, wherein the connection portion runs at an angle—preferably at a right angle—to the first bearing surface and the second bearing surface. The first bearing surface may be part of a first bearing portion and the second bearing surface part of a second bearing portion.

The first bearing surface and the second bearing surface may be provided at opposite ends of the connection portion. The first bearing surface may extend from one end of the connection portion preferably radially outwards. The connection portion may enclose the second bearing surface with its other end. The first bearing surface may form a circumferential edge around the end of the connection portion assigned to it. Unlike the first bearing surface, the second bearing surface may extend within the end of the connection portion.

The connection portion and the second bearing portion may define the receiving means of the adapter body. The second bearing surface may form a base of the receiving means. The connection portion may form a circumferential wall of the receiving means and define the receiving means along with the second bearing surface forming the base of the receiving means. Starting from the first bearing surface, the receiving means may extend within the connection portion up to the second bearing surface. The contour of the bearing surfaces and the contour of the adapter body may be adapted to the shape of the bearing surfaces on the brake application device and the vehicle, in order to allow the most planar abutment possible.

The receiving means may have a first opening for the passage of a portion of at least a first fastening bolt for fastening the brake application device to a vehicle. In addition, the receiving means may exhibit a second opening for the passage of a portion of at least a second fastening bolt for fastening the brake application device to a vehicle. The first opening, the second opening and the recess may each have a center axis. The center axes of the first opening, of the second opening and of the recess may lie in a common plane. The recess may be arranged between the first opening and the second opening.

The recess for the passage of a portion of the force input unit has a larger diameter compared with the first opening and the second opening. The diameter of the first opening and of the second opening may be identical, since the two fastening bolts for fastening the brake application device to a vehicle usually have the same outer diameter.

The recess in the second bearing surface may have a conically tapering circumferential wall which is adapted to the outer contour of the force input unit. The internal diameter of the recess may be reduced by the conical circumferential wall. The circumferential wall of the recess may, in addition, project into the recess and the internal diameter of the recess may diminish, the further the circumferential wall of the recess extends into the receiving means.

The present invention further relates to an adapter unit having at least one adapter body designed as described and at least one fastening bolt for fastening the brake application device to a vehicle. The at least one fastening bolt extends through the receiving means of the at least one adapter body. The at least one fastening portion may penetrate the adapter body through the opening in the receiving means and then extend through the receiving means of the adapter body.

The at least one fastening bolt may be fixedly connected at one of its ends to the brake application device. For this purpose, this end may be provided with a thread with which the fastening bolt can be screwed to the brake application device. The at least one fastening bolt may be coupled with the vehicle at its other end. For this purpose, the fastening bolt may likewise have a thread at this end which can be guided through an opening in the bulkhead of a vehicle and fastened to the bulk-head of the vehicle using a nut. The fastening bolt transmits the forces acting on the brake application device during actuation of the brake pedal to the vehicle. The fastening bolts in this case act as tension bolts.

The adapter unit may have at least one nut which interacts with the at least one fastening bolt. The at least one nut may be screwed to the fastening bolt in order to hold the adapter body on the brake application device. The at least one nut may bear against the second bearing surface or the base of the receiving means of the adapter body for this purpose.

In addition, the present invention relates to a brake application device. The brake application device comprises a force input unit which can be coupled with a brake pedal of a vehicle and at least one adapter body or an adapter unit, wherein at least one fastening bolt is fixedly connected to the brake application device and extends through the receiving means of the adapter body.

The brake application device may have a master brake cylinder to which the wheel brakes of a vehicle can be attached. The brake application device may have a braking pressure generation unit. The braking pressure generation unit may be coupled with the master brake cylinder. The braking pressure generation unit may have a brake servo unit which is used to boost the brake application force exerted by a driver on the brake pedal. The brake servo unit may boost braking electromagnetically, hydraulically or pneumatically. The boosted application force is transmitted to the master brake cylinder, in order to produce a braking pressure which corresponds to the application force required by the driver hydraulically. The master brake cylinder applies the hydraulic braking pressure to the downstream wheel brakes in order to trigger a braking action. The braking pressure generation unit may, in addition, have sensors which detect the application force exerted on the force input unit by a driver by means of the brake pedal.

The brake servo unit may, for example, have an electromechanical brake servo. The electromechanical brake servo may comprise a motor, a control unit, a gearing mechanism and an application device. The application device may be coupled with the master brake cylinder. The application device may be coupled with a force input unit or with the force input member of the force input unit. The application device may be acted upon via the force input unit or the force input member coupled with the brake pedal by the braking force exerted by the driver on the brake pedal. The boost to be provided by the electromechanical brake servo may depend on an application force by the driver detected by means of the sensors, for example, or on commands received from a vehicle dynamics control program. The booster force and also the application force exerted by the driver on the brake pedal are transmitted to the master brake cylinder via the application device. The boosting is produced by means of the electric motor and the gearing mechanism which drive the application device. For this purpose, the application device is moved by the electric motor and the gearing mechanism in the direction of the master brake cylinder, in order to introduce the boosting force requested by the driver into the master brake cylinder.

Alternatively, a braking force requested by the driver via the brake pedal and detected by the sensors may be completely generated by means of an electromechanical drive unit with an electric motor and/or a gearing mechanism, for example. The force generated by the drive unit may be transmitted to the master brake cylinder located downstream or a hydraulic pressure generator inserted in between, in order to generate the braking pressure required for a braking action on the wheel brakes located downstream. According to this alternative, the master brake cylinder is not coupled with the force input unit during normal operation of the vehicle brake. The application force exerted on the force input unit by the driver via the brake pedal instead acts on a counter-force simulation mechanism, so that the driver receives a customary response from the brake application device via the simulated counter-force. Brake application devices of this kind are frequently referred to as brake-by-wire application devices. An exemplary embodiment of an adapter body is described in greater detail below with the help of the attached schematic figures.

### BRIEF DESCRIPTION OF THE DRAWINGS

In the figures:

FIG. 1 shows a perspective view of an adapter body;

FIG. 2 shows a front view of the adapter body from FIG. 1;

FIG. 3 shows a side view of the adapter body from FIG. 1;

FIG. 4 shows a sectional view of the adapter body from FIG. 1;

FIG. 5 shows a side view of a brake application device with an adapter body arranged thereon; and

FIG. 6 shows a perspective view of a brake application device with the adapter body arranged thereon.

### DETAILED DESCRIPTION

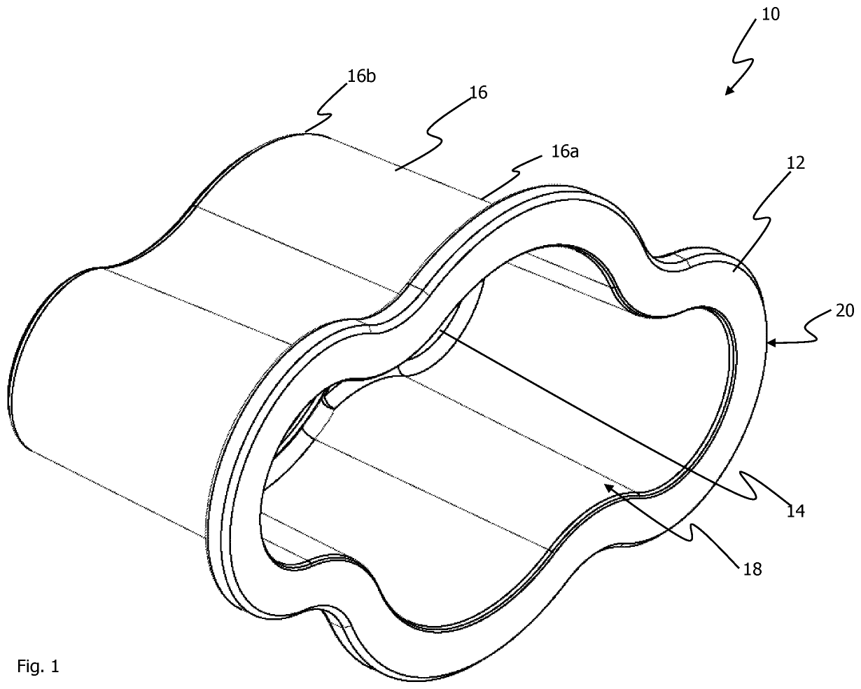

FIG. 1 shows a perspective view of an adapter body 10. The adapter body 10 has a first bearing surface 12 and a second bearing surface 14 only recognizable sectionally in FIG. 1. The first bearing surface 12 and the second bearing surface 14 are connected to one another via a connection portion 16. The adapter body 10 has a receiving means 18 which is defined by the second bearing surface 14 and the connection portion 16. The connection portion 16 forms the wall and the second bearing surface 14 the base of the receiving means 18. The first bearing surface 12 is configured on a flange-like projection 20 of a first end region 16a of the connection portion 16. The second bearing surface 14 is configured on a second end region 16b of the connection portion 16 and extends completely within the second end region 16b of the connection region 16.

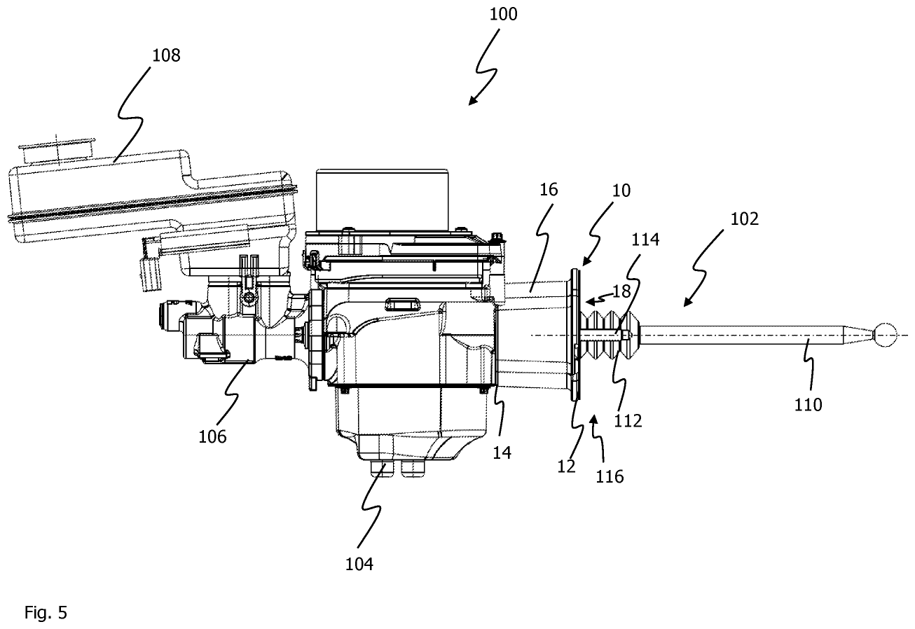

The first, in this case annular, bearing surface 12 is designed to bear against a bulkhead of a vehicle and extends at right angles from the connection region 16a, in this case radially outwardly, and runs parallel to the second bearing surface 14. The adapter body 10 is configured overall with a cup-shaped or pot-shaped design. The outer contour of the adapter body 10 may be adapted to the shape of the corresponding bearing surfaces of the bulkhead (not shown) of a vehicle and a brake application device 100 (see FIG. 5). The first bearing surface 12 forms an inner circumferential edge which surrounds the connection portion 16 and at the same time forms the edge of the receiving means 18 configured therein.

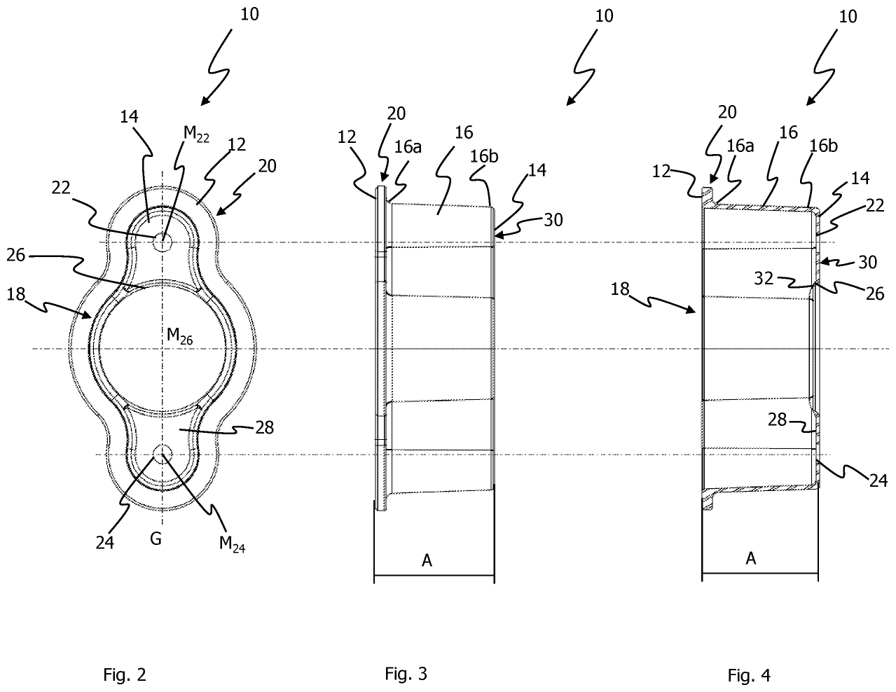

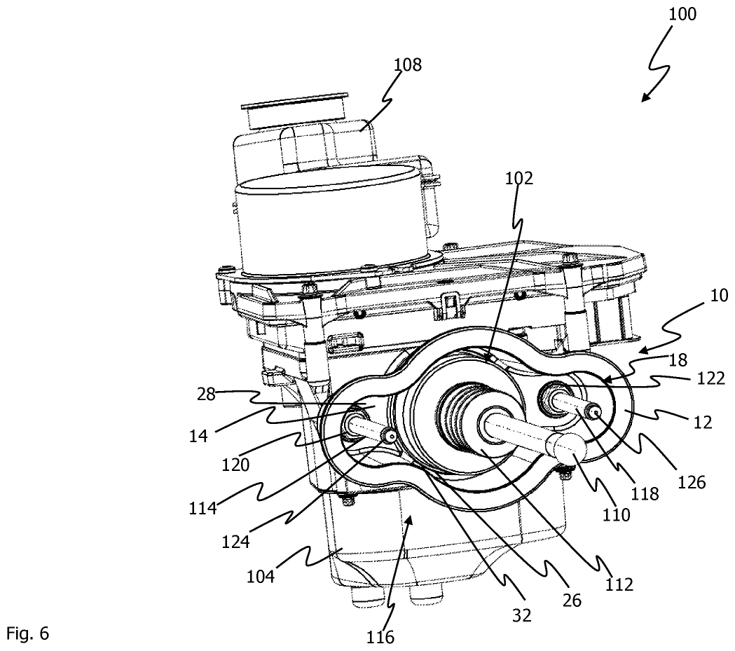

FIG. 2 shows a front view of the adapter body 10 with the first bearing surface 12, the second bearing surface 14 and the receiving means 18. The receiving means 18 is provided with a first opening 22 and a second opening 24. The first opening 22 and the second opening 24 may each receive a fastening bolt 114, 118 (see FIG. 6) which is used for fastening a brake application device not shown in FIG. 2 to a vehicle. The receiving means 18 also has a recess 26 which receives a portion of a force input unit 102 (see FIG. 6) of the brake application device which is not shown. The first opening 22, the second opening 24 and the recess 26 are configured in the second bearing surface 14 which forms the base of the receiving means 18. The inner side 28 of the second bearing surface 14 which forms the base surface of the receiving means 18 is shown in FIG. 2.

The recess 26 has a larger internal diameter than the first opening 22 and the second opening 24. The first opening 22 and the second opening 24 have an identical internal diameter in this case. The inner contour of the first annular bearing surface 12, and therefore that of the adapter body 10, is adapted to the internal diameter of the openings 22, 24 and the recess 26. The adapter body 10 has a larger cross section in its center region, in which the recess 26 is arranged, than in the regions in which the first opening 22 and the second opening 24 are formed.

The first opening 22, the second opening 24 and the recess 26 each have a center axis M₂₂, M₂₄, M₂₆ running in the longitudinal direction of the adapter body 10. The center axes M₂₂, M₂₄, M₂₆ of the openings 22, 24 and the recess 26 lie in a common plane G which at the same time forms a plane of symmetry of the adapter body 10. The recess 26 is arranged centrally between the first opening 22 and the second opening 24. In addition, the cross section of the adapter body 10 increases starting from the region with the opening 22 until it reaches its greatest cross section level with the center axis M₂₆ of the recess 26. From this point, the cross section of the adapter body 10 diminishes again up to the region in which the opening 24 is arranged.

FIG. 3 shows a side view of the adapter body 10. The connection portion 16 which sets a predetermined distance A between the first bearing surface 12 and the second bearing surface 14 extends between the first bearing surface 12 and the second bearing surface 14. The first bearing surface 12 extends from the first end 16a of the connection portion 16 at right angles radially outwardly. The second bearing surface 14 extends within the connection portion 16. The second bearing surface 14 has an outer side 30 which is designed to bear against a brake application device 100 (see FIG. 5). The first bearing surface 12 and the outer side 30 of the second bearing surface 14 are therefore formed on opposite sides of the adapter body 10 and extend parallel to one another here.

FIG. 4 shows a sectional view of the adapter body 10. The adapter body 10 is configured as a hollow shaped body, i.e. the adapter body 10 is cup-shaped or pot-shaped. The adapter body 10 may be an aluminum injection-molded part. The adapter body 10 has a receiving means 18 which is delimited by the connection portion 16 and the second bearing surface 14. The second bearing surface 14, more accurately the inner side 28 thereof, therefore forms the base of the receiving means 18. The openings 22, 24 and the recess 26 are formed in the second bearing surface 14. The recess 26 has an inclined circumferential wall 32 extending into the receiving means 18. The circumferential wall 32 is adapted to a complementary portion of the outer contour of a force input unit of the brake application device which is not shown here. The circumferential wall 32 may bear against this portion if this portion of the force input unit is received by the recess 26.

The first bearing surface 12 extends outwardly from the end region 16a of the connection portion 16. The second bearing surface 14 extends inwardly from the second end region 16b of the connection portion 16. The first bearing surface 12 and the second bearing surface 14 are at a predetermined distance A from one another. By means of the adapter body 10, a predetermined distance between a bulkhead (not shown) of a vehicle and a brake application device 100 (see FIG. 5) can be set. The outer side 30 of the second bearing surface 14 is designed to bear against a corresponding bearing surface of the brake application device 100. The first bearing surface 12 which surrounds the receiving means 18 is designed to bear against a corresponding bearing surface of a bulkhead of a vehicle.

Fastening bolts 114, 118 (see FIG. 6) which are used to fasten the brake application device to a vehicle may extend through the openings 22, 24. The fastening bolts 114, 118 penetrate the adapter body 10 through the openings 22, 24 and extend through the entire receiving means 18. The same applies to the force input unit 102 of a brake application device not shown in FIG. 4. This extends through the recess 26 into the receiving means 18 and through the entire receiving means 18, so that it can be mechanically coupled with a brake pedal of a vehicle.

FIG. 5 shows a side view of the brake application device 100 with the adapter body 10 arranged thereon. The brake application device 100 comprises a force input unit 102 and a brake pressure generation unit 104. The brake pressure generation unit 104 is coupled with a master brake cylinder 106. A container 108 for hydraulic fluid is arranged on the master brake cylinder 106, which container supplies hydraulic fluid to the brake circuits connected to the master brake cylinder 106.

The force input unit 102 has a force input member 110 and a bellows 112 which sectionally encloses the force input member 110 and seals the force input unit 102. The force input member 110 may be mechanically coupled with a brake pedal. The force input unit 102 extends through the adapter body 10, wherein the force input member 110 projects from the adapter body 10 along with the bellows 112.

In addition, a fastening bolt 114 is shown in FIG. 5 which is fixedly connected to the brake application device 100. The fastening bolt 114 creates an adapter unit 116 along with the adapter body 10. The fastening bolt 114 is used to fasten the brake application device 100 to a vehicle (not shown). The adapter body 10 lies with its second bearing surface 14 against the brake application device 100 or the braking pressure generation unit 104. The connection portion 16 of the adapter body 10 extends from the second bearing surface 14 in the direction of the force introduction member 110. At the end of the connection portion 16 opposite the second bearing surface 14, the first bearing surface 12 can be seen which is designed to bear against a bulkhead of a vehicle. Like the force input unit 102, the fastening bolt 114 also extends through the receiving means 18 of the adapter body 10 which is defined by the connection portion 16 and the bearing surface 14.

FIG. 6 shows a perspective view of the brake application device 100 with the adapter body 10 arranged thereon. Fastening bolts 114 and 118 and also the force input unit 102 of the brake application device 100 extend in the receiving means 18 of the adapter body 10. The recess 26 in the second bearing surface 14 of the adapter body 10 lies with its circumferential wall 32 against the outer contour of the force input unit 102. The circumferential wall 32 of the recess 26 projects axially conically into the receiving means 18. The adapter body 10 lies with the outer side 30 of the second bearing surface 14 on the brake application device 100 or on the braking pressure generation unit 104. The fastening bolts 114, 118 and also the force input unit 102 extend within the receiving means 18 of the adapter body 10 through the adapter body 10.

The adapter unit 116 is provided with nuts 120 and 122 which are screwed using the fastening bolts 114, 118. Using the nuts 120, 122, the adapter body 10 can be held in its predetermined position on the brake application device 100. The nuts 120, 122 bear against the inner side 28 of the second bearing surface 14 for this purpose. The nuts 120, 122 press the second bearing surface 14 against the brake application device 100. Washers may be located between the inner side 28 of the bearing surface 14 and the nuts 120, 122.

The fastening bolts 114, 118 have a thread at their ends 124, 126. Using this thread, the fastening bolts 114, 118 can be attached to the bulkhead of a vehicle. For this purpose, the fastening bolts 114, 118 are inserted through openings in the bulkhead of the vehicle (not shown) and the first bearing surface 12 of the adapter body 10 is moved into abutment with the bulkhead. On the side of the bulkhead facing away from the brake actuation device 100 and the adapter body 10, nuts are screwed onto the end portions 124, 126 of the fastening bolts 114, 118 provided with a thread, in order to fasten the brake application device 100 to the vehicle. By tightening these nuts (not shown), tensile forces are exerted on the fastening bolts 114, 118. The fastening bolts 114, 118 are coupled fixedly and in a tensile force-transmitting manner, for example screwed, with the brake application device 100 at their ends opposite the end portions 124, 126. The fastening bolts 114, 118 therefore act as tensioning bolts.

Tensile forces occurring during assembly of the brake application device 100 are not transmitted to the adapter body 10, as the fastening bolts 114, 118 extend through the adapter body 10 and the adapter body 10 is only held in a clamping manner between the brake application device 100 and the bulkhead of the vehicle which is not shown.

The brake application device 100 may be actuated via a brake pedal (not shown) by a driver of a vehicle. The brake pedal in the vehicle interior is coupled with the force input member 110. The force input member 110 transmits the application force exerted by the driver on the brake pedal to the force input unit 102 which in turn actuates the brake pressure generation unit 104. Via the brake pedal and the force input member 110 of the force input unit 102, pressure forces are transmitted to the brake application device 100 when the brake is actuated. Since, however, the brake application device 100 is fastened to the vehicle via the fastening bolts 114, 118, the fastening bolts 114, 118 are exposed to tensile forces when the brake is applied. Since no tensile force-transmitting connection exists between the adapter body 10 and the vehicle and the fastening bolts 114, 118 and the force input unit 102 extend through the receiving means 18 of the adapter body 10, no tensile forces act on the adapter body 10 during a brake application. This means that the adapter body 10 permanently retains its shape and has a longer service life.

1. An adapter body (10) for a brake application device (100) of a vehicle braking system comprising:
a first bearing surface (12) which is designed to bear against a bulkhead of a vehicle,
a second bearing surface (14) which is designed to bear against the brake application device (100), wherein the first bearing surface (12) and the second bearing surface (14) are at a predetermined distance (A) from one another,
wherein a receiving means (18) for a portion of at least one fastening bolt (114, 118) for fastening the brake application device (100) to a vehicle is configured in the adapter body (10).

2. The adapter body as claimed in claim 1, wherein the receiving means (18) also has a region for receiving a portion of a force input unit (102) of the force application device (100).

3. The adapter body as claimed in claim 1 or 2, wherein the receiving means (18) has at least one opening (22, 24) for passage of a portion of the at least one fastening bolt (114, 118) and/or a recess (26) for passage of a portion of the force input unit (102) of the brake application device (100).

4. The adapter body as claimed in one of claims 1 to 3, further comprising a connection portion (16) which connects the first bearing surface (12) and the second bearing surface (14) to one another and sets the predetermined distance (A) between the first bearing surface (12) and the second bearing surface (14).

5. The adapter body as claimed in claim 4, wherein the first bearing surface (12) and the second bearing surface (14) are configured at opposite ends (16a, 16b) of the connection portion (16).

6. The adapter body as claimed in claim 5, wherein the first bearing surface (12) extends outwardly from one end (16a) of the connection portion (16) and the connection portion (16) encloses the second bearing surface (14) with its other end (16b).

7. The adapter body as claimed in one of claims 4 to 6, wherein the connection portion (16) and the second bearing surface (14) define the receiving means (18), the second bearing surface (14) forming the base of the receiving means (18).

8. The adapter body as claimed in one of claims 3 to 7, wherein the at least one opening (22, 24) and the at least one recess (26) are formed in the second bearing surface (14).

9. The adapter body as claimed in one of claims 1 to 8, wherein the receiving means (18) has a first opening (22) for the passage of a portion of at least a first fastening bolt (114) for fastening the brake application device (100) to a vehicle and a second opening (24) for the passage of a portion of at least a second fastening bolt (118) for fastening the brake application device (100) to a vehicle.

10. The adapter body as claimed in claim 9, wherein the first opening (22), the second opening (24) and the recess (26) each have a center axis (M₂₂, M₂₄, M₂₆), the center axes (M₂₂, M₂₄, M₂₆) of the first opening (22), the second opening (24) and the recess (26) lie in one and the same plane (G).

11. An adapter unit (116) having at least one adapter body (10) as claimed in one of claims 1 to 10 and at least one fastening bolt (114, 118) for fastening the brake application device (100) to a vehicle, wherein a portion of the at least one fastening bolt (114, 118) is received in the receiving means (18) of at least one adapter body (10).

12. The adapter unit as claimed in claim 11, further comprising at least one nut (120, 122) for screwing to the at least one fastening bolt (114, 118).

13. A brake application device (100), comprising:
a force input unit (102) which can be coupled with a brake pedal of a vehicle, and
at least one adapter body (10) as claimed in one of claims 1 to 10 or an adapter unit (116) as claimed in claim 11 or 12, wherein at least one fastening bolt (114, 118) is fixedly connected to the brake application device (100) and extends through the receiving means (18) of the adapter body (10).

14. The brake application device as claimed in claim 13, further comprising a braking pressure generation unit (104).

15. The brake application device as claimed in claim 14, further comprising a master brake cylinder (106) which can be coupled with the braking pressure generation unit (104).
